(19) United States
(12) Patent Application Publication
(10) Pub. No.: US 2005/0076217 A1
(43) Pub. Date: Apr. 7, 2005

(54) Integrating a device into a secure network

(76) Inventors: Christopher J. Lord, Portland, OR (US); Carl M. Ellison, Portland, OR (US); David W. Bowler, Beaverton, OR (US)

Correspondence Address: FISH & RICHARDSON, PC, 12390 EL CAMINO REAL, SAN DIEGO, CA, 92130-2081, US

(21) Appl. No.: 10/678,745

(22) Filed: Oct. 3, 2003

(51) Int. Cl. H04L 9/00

(52) U.S. Cl. 713/171

(57) ABSTRACT

A method of integrating a device into a secure network. The method includes establishing a tunnel between an authenticator, which has a first public key and a first secret, and a device, which has a second secret and a second public key. The method also includes hashing the first secret at the authenticator using the first public key, the second public key and a random number generated from the tunnel protocol to produce a hash of the first secret. The method further includes establishing an authenticated session between the device and the authenticator when the hash of the first secret matches a hash of the second secret.

### BACKGROUND

Network authenticators such as intelligent switches and access points provide authenticated access control of endpoints requesting access to a secure network. Endpoints may be devices such as personal computers (PCs), wireless-cameras or the like. Typical methods for authentication between the network authenticator and the network endpoint include mutually authenticating each other to establish a secure session based on public keys and secure secrets.

A hash function is a function that converts an input from a typically large domain into an output in a typically smaller range. A hash value is a number generated from a string of bits using a hash function. The hash value is typically substantially smaller than the input string of bits itself, and is generated by a formula. Hash functions are used in hash tables, cryptography and data processing.

### DESCRIPTION OF THE DRAWINGS

FIG. 1 is a block diagram of a secure network system.

FIG. 2 is a flowchart of a process for integrating a device into the secure network system.

FIG. 3 is a flowchart of a process for validating a hash value of a public key for a device.

FIG. 4 is a flowchart of a process for challenging a secret.

FIG. 5 is a flowchart of a process for establishing a connection between the device and the secure network system.

FIG. 6 is a block diagram of a computer system on which the process of FIG. 2 may be implemented.

### DESCRIPTION

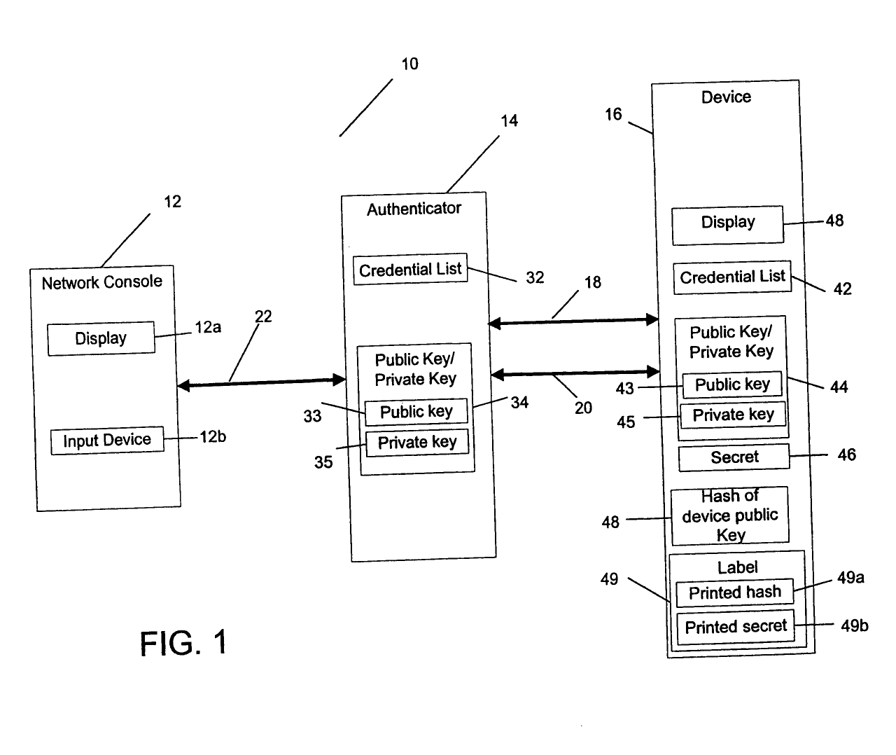

Referring to FIG. 1, a secure network system 10 includes a network console 12, an authenticator 14, and a device 16 (i.e., an endpoint), which attempts to gain access to the secure system through the authenticator 14. Authenticator 14 is used to determine whether device 16 has proper credentials to gain access to secure network system 10. Initially, authenticator 14 and device 16 communicate with each other through an unauthenticated channel 18 to determine whether the device has the proper credentials; and once the device has been authenticated, the authenticator and the device communicate through an authenticated channel 20.

Network console 12 includes a display 12a and an input device 12b (e.g., a keyboard). Network console 12 is a user interface that allows a user to interact with authenticator 14 and device 16. A protocol channel 22 connects authenticator 14 to network console 12. A protocol, used on channel 22, may be a self-configuring protocol. The protocol may include discovery, eventing or control operations or any combination thereof. Eventing includes sending or receiving event signals. For example, the protocol may be the Universal Plug and Play Protocol (UPnP™).

Authenticator 14 includes a credential list 32 and a public key/private key pair 34 that includes a public key 33 and a private key 35. Credential list 32 includes public keys from other devices not shown that have been previously authenticated or have been previously added using network console 12. The public keys in credential list 32 are used in future network access authentications.

Public key 33 is an identifier of authenticator 14 that is recognized by a device for authentication after a successful introduction process. Public key 33 and private key 35 may be generated as part of a manufacturing process. In other techniques, public key 33 and private key 35 may be generated when authenticator 14 is powered-on for the first time.

Device 16 includes a credential list 42, a public/private key pair 44 (that includes a public key 43 and a private key 45), a secret 46, a hash value 48 of public key 43 and a label 49. Public key 43 is an identifier of device 16 that is recognized by an authenticator for authentication after a successful introduction process. Public key 43 and private key 45 may be generated as part of a manufacturing process. In other embodiments, public key 43 and private key 45 may be generated by device 16, either when the device is powered-on for the first time or at some other appropriate time.

Secret 46 includes a human intelligible string. Credential list 42 includes public keys from other authenticators not shown that have been previously authenticated or have been previously added by some other process.

Label 49 includes a printed hash value 49a that corresponds to hash 48 and a printed secret 49b that corresponds to secret 46. As will be shown below, printed hash 49a and printed secret 49b are used to mutually authenticate device 16 and the network system 10. The printed hash 49a is used to validate that the public key 43 sent to network system 10 actually came from device 16, and the printed secret 49b is used to validate that the network system 10 is a network with which the device 16 intends to connect.

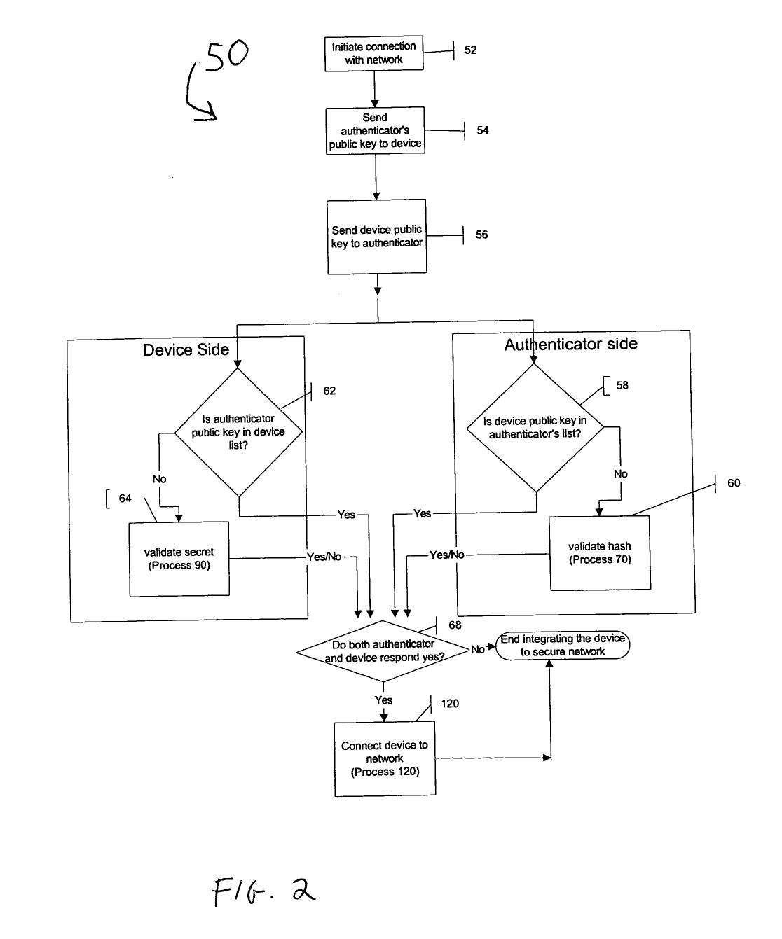

Referring to FIG. 2, an exemplary process 50 for integrating device 16 into secure network 10 is shown. Process 50 initiates 52 a connection between device 16 with secure network 10 through unauthenticated channel 18. Process 50 sends 54 a public key 33 from authenticator 14 to device 16. Process 50 sends 56 public key 43 from device 16 to authenticator 14. A point-to-point protected tunnel may be established between device 16 and authenticator 14.

At authenticator 14, process 50 determines 58 whether device public key 43 is on credential list 32 of authenticator 14. If device public key 43 is not on credential list 32 of authenticator 14, process 50 validates the hash value 48 by sending a key query 60 to network console 12.

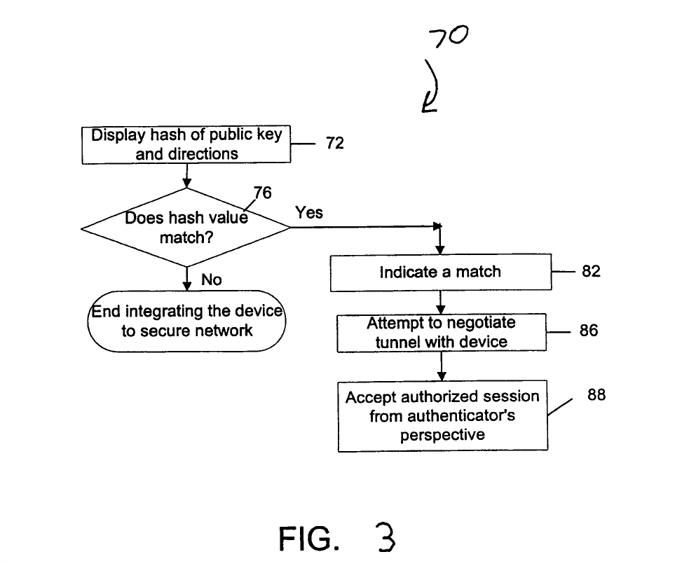

Referring to FIG. 3, an exemplary process for validating hash value 48 is executing a process 70. Process 70 displays 72 on display 12a of network console 12 a hash of public key 43. Process 70 determines 76 whether hash value 48 received from authenticator 14 matches printed hash 49a. For example, the user at console 12 looks at printed hash 49a on device 16. If hash value 48 does not match printed hash 49a, process 70 ends. For example, the user terminates the connection process. If hash value 48 does match printed hash 49a, process 70 indicates 82 a match. For example, the user can select an icon (not shown) on network console 12 or send a message indicating a match.

Process 70 attempts 86 to negotiate a tunnel using a tunnel protocol with device 16 from authenticator 14. The tunnel protocol allows authentication between authenticator 14 and device 16 and the negotiation of an encryption algorithm and cryptographic keys before an application protocol transmits or receives any data. Process 70 accepts 88 the session for the authenticator 14 side. Device 16 side of process 50 may not yet be complete.

Referring back to FIG. 2, at device 14, process 50 determines 62 whether authenticator public key 33 is in credential list 42. If authenticator public key 33 is not in credential list 42, process 50 challenges 64 printed secret 49b.

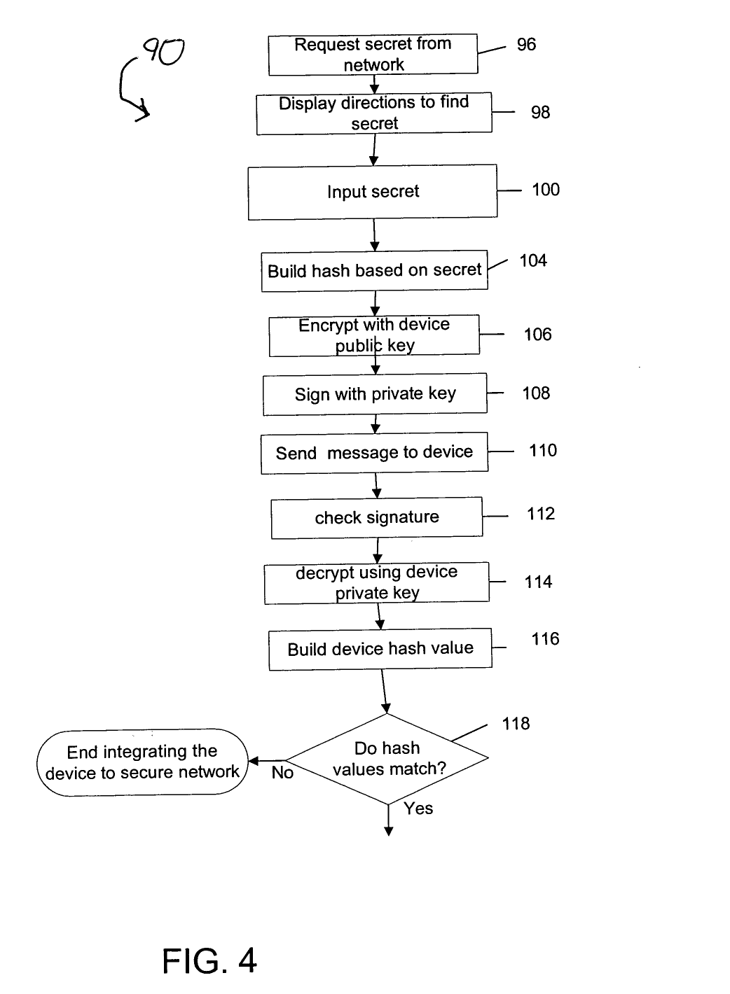

Referring to FIG. 4, an exemplary process 90 for challenging 90 printed secret 49b is shown. Process 90 requests 96 printed secret 49b from the secure network 10. Process 90 displays 98 directions to find printed secret 49b on label 49. Process 90 inputs 100 printed secret 49b into network console 12. For example, the user loads printed secret 49b into network console 12 using keyboard 12b.

Process 90 builds 104 a hash of printed secret 49b and other relevant values. The hash function used to generate the hash is a function of public key 33, public key 43, printed secret 49b, and a random number generated from the tunnel protocol. Process 90 encrypts 106 with public key 43 received from device 16 into a message. Process 90 optionally signs 108 with private key 35 to generate a signature. Process 90 sends 110 the message to device 16.

The building of the hash can occur either in network console 12 or authenticator 14. If it occurs in network console 12, authenticator 14 will forward authenticator 14 public key 33, device 16 public key 43, and the random number generated from the protocol tunnel to the network console 12. If it occurs in the authenticator 14, the network console 12 will forward the printed secret 49b to authenticator 14. Encrypting 106 of the hash built 104 occurs at the same location the hash was built.

Process 90 may check 112 the signature of the message using public key 33 received from authenticator 14. Process 90 decrypts 114 the message using private key 45.

Process 90 builds 116 a second hash value of secret 46 using a hash function based on secret 46, public key 33, public key 43 and a randomly generated number from the tunnel protocol. Process 90 determines 118 whether the hash value sent by the authenticator 14 or network console 12 matches the hash value generated on the device 16. If the hash values of the secrets do not match, process 90 and process 50 end. If the hash values of the secrets do match, device 16 will accept the session with the authenticator 14. Authenticator 14 side of process 50 may not yet be complete.

Referring to FIG. 2, process 50 determines 68 if the components, authenticator 14 and device 16, have each validated the other component. If one of the components, authenticator 14 or device 16, have invalidated the other component, process 50 ends without connection. For example, the protected tunnel is dropped. If both components validate the other component, process 50 establishes 120 a connection with the secure network through authenticated channel 20.

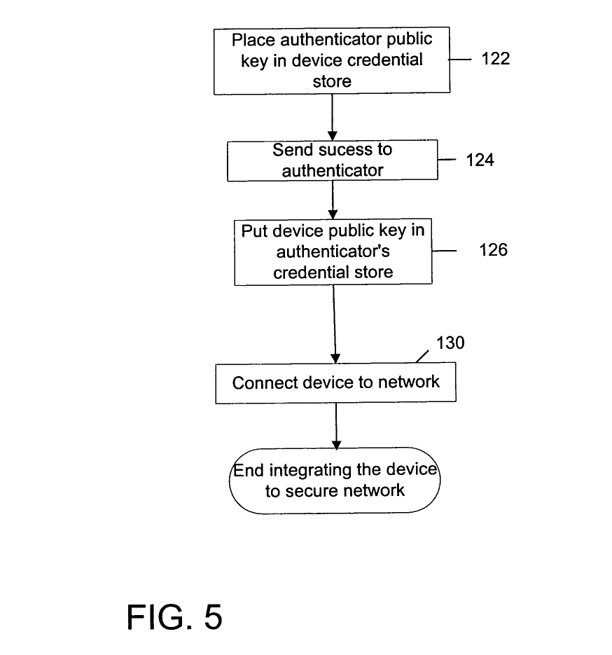

Referring to FIG. 5, an exemplary process for establishing a connection is a process 120. Process 120 places 122 public key 33 in credential list 42 of device 16 if it is not already stored. Process 120 sends 124 a success message to authenticator 14. Process 120 places 126 the public key 43 into credential list 32 of authenticator 14 if it is not already stored. Process 120 connects 130 device 16 to network 10.

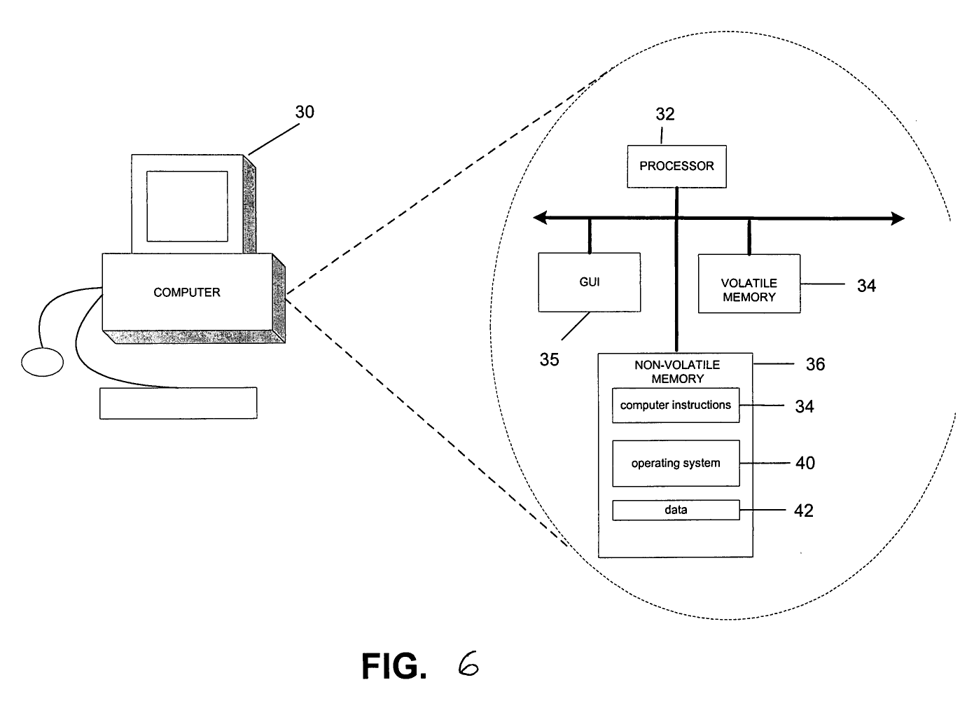

FIG. 6 shows a computer 200 for using process 50. Computer 100 includes a processor 202, a memory 204, and a storage medium 206 (e.g., hard disk). Storage medium 206 stores operating system 210, data storage 212, and computer instructions 214 which are executed by processor 202 out of memory 204 to perform process 50.

Process 50 is not limited to use with the hardware and software of FIG. 6; they may find applicability in any computing or processing environment and with any type of machine that is capable of running a computer program. Process 50 may be implemented in hardware, software, or a combination of the two. For example, process 50 may be implemented in a circuit that includes one or a combination of a processor, a memory, programmable logic and logic gates. Process 50 may be implemented in computer programs executed on programmable computers/machines that each includes a processor, a storage medium or other article of manufacture that is readable by the processor including volatile and non-volatile memory and/or storage elements), at least one input device, and one or more output devices. Program code may be applied to data entered using an input device to perform process 50 and to generate output information.

Each such program may be implemented in a high level procedural or object-oriented programming language to communicate with a computer system. However, the programs can be implemented in assembly or machine language. The language may be a compiled or an interpreted language. Each computer program may be stored on a storage medium or device e.g., CD-ROM, hard disk, or magnetic diskette that is readable by a general or special purpose programmable computer for configuring and operating the computer when the storage medium or device is read by the computer to perform process 50. Process 50 may also be implemented as one or more machine-readable storage media, configured with a computer program(s), where upon execution, instructions in the computer program(s cause a computer to operate in accordance with process 50.

Process 50 is not limited to the specific embodiments described herein. For example, device 16 may be a laptop PC, a small-embedded device without a user input/output capability (such as a digital wireless camera), a stereo system, a speaker, a personal digital assistant and the like. The device may be a cellular phone, a modem, a digital player or other consumer electronic product. The device may include a display, memory, a processor and circuitry to connect to a secure network.

Authenticator 14 may be located in a centralized network-side server. In other embodiments, authenticator 14 may be located in a hub, switch, or wireless access point as in small ‘server-less’ home or small office/home office (SOHO) networks.

In still other embodiments, instead of using a label 49, an application may display secret 49b and hash value 49a.

In some embodiments, network console 12 may be located on the same machine as authenticator 14. This may negate the messages sent between network console 12 and authenticator 14.

Processes 50, 70, 90 and 120 are not limited to the specific processing order of FIGS. 2 to 5. Rather, the blocks of FIGS. 2 to 5 may be re-ordered, as necessary, to achieve the results set forth above.

Other embodiments not described herein are also within the scope of the following claims.

1. A method of integrating a device into a secure network, comprising:
establishing a tunnel between an authenticator and a device, the tunnel using a tunnel protocol, the authenticator having a first public key, the device having a second secret and a second public key;
hashing a first secret using the first public key, the second public key and a random number generated from the tunnel protocol to produce a hash of the first secret; and
establishing an authenticated session between the device and the authenticator when the hash of the first secret matches a hash of the second secret.

2. The method of claim 1, further comprising:
hashing the second secret at the device to produce the hash of the second secret using the first public key, the second public key and a second random number generated from the tunnel protocol.

3. The method of claim 1, wherein the authenticator has a first private key, the method further comprising:
encrypting the hash of the first secret using the second public key; and
placing the encrypted hash into a message.

4. The method of claim 3, further comprising signing the message with the first private key with a digital signature.

5. The method of claim 3, wherein the device comprises a second private key; and further comprising:
checking the digital signature using a first public key; and
decrypting the message using the second private key.

6. The method of claim 1, further comprising:
determining if a hash value of the second public key matches a displayed hash value observed at the device; and
determining if the first secret matches a displayed secret observed at the device;
wherein the second secret is the displayed secret after entry into a network console connected to the authenticator.

7. The method of claim 6, wherein the device includes a label having the displayed hash value and the displayed secret.

8. The method of claim 5, wherein determining if the hash value of the second public key matches comprises:
reading the displayed hash value; and
verifying the displayed hash value at a network console.

9. The method of claim 5, wherein determining if secret matches comprises:
reading the displayed secret; and
entering the displayed secret at a network console.

10. The method of claim 5, wherein the device comprises a display and an application, the application rendering the displayed hash value and the displayed secret on the display.

11. The method of claim 1, wherein the authenticator comprises a first credential list and the device comprises a second credential list, the method further comprising:
determining if the public key from the device is on the first credential list; and
determining if a public key from the device is in the second credential list.

12. The method of claim 1, wherein the authenticator comprises a first credential list and the device comprises a second credential list, the method further comprising:
placing the first public key in the second credential list; and
placing the second public key in the first credential list.

13. An apparatus comprising:
circuitry, for integrating a device into a secure network, to:
establish a tunnel between an authenticator and the device, the tunnel using a tunnel protocol, the authenticator having a first public key, the device having a second secret and a second public key;
hash a first secret using the first public key, the second public key and a random number generated from the tunnel protocol to produce a hash of the first secret; and
establish an authenticated session between the device and the authenticator when the hash of the first secret matches a hash of the second secret.

14. The apparatus of claim 13, further comprising circuitry to:
hashing the second secret at the device to produce the hash of the second secret using the first public key, the second public key and a second random number generated from the tunnel protocol.

15. The apparatus of claim 13, wherein the authenticator has a first private key, further comprising circuitry to:
encrypt the hash of the first secret using the second public key; and
place the encrypted hash into a message.

16. The apparatus of claim 15, further comprising circuitry to sign the message with the first private key with a digital signature.

17. The apparatus of claim 15, wherein the device comprises a second private key; and further comprising circuitry to:
check the digital signature using a first public key; and
decrypt the message using the second private key.

18. The apparatus of claim 13, further comprising circuitry to:
determine if a hash value of the second public key matches a displayed hash value observed at the device; and
determine if the first secret matches a displayed secret observed at the device;
wherein the second secret is the displayed secret after entry into a network console connected to the authenticator.

19. The apparatus of claim 18, wherein the device includes a label having the displayed hash value and the displayed secret.

20. The apparatus of claim 17, wherein to determine if the hash value of the second public key matches comprises:
reading the displayed hash value; and
verifying the displayed hash value at a network console.

21. The apparatus of claim 17, wherein to determine if secret matches comprises:
reading the displayed secret; and
entering the displayed secret at a network console.

22. The apparatus of claim 17, wherein the device comprises a display and an application, the application rendering the displayed hash value and the displayed secret on the display.

23. The apparatus of claim 13, wherein the authenticator comprises a first credential list and the device comprises a second credential list, further comprising circuitry to:
determine if the public key from the device is on the first credential list; and
determine if a public key from the device is in the second credential list.

24. The apparatus of claim 13, wherein the authenticator comprises a first credential list and the device comprises a second credential list, further comprising circuitry to:
place the first public key in the second credential list; and
place the second public key in the first credential list.

25. An article comprising a machine-readable medium that stores executable instructions for integrating a device into a secure network, the instructions causing a machine to:
establish a tunnel between an authenticator and the device, the tunnel using a tunnel protocol, the authenticator having a first public key, the device having a second secret and a second public key;
hash a first secret using the first public key, the second public key and a random number generated from the tunnel protocol to produce a hash of the first secret; and
establish an authenticated session between the device and the authenticator when the hash of the first secret matches a hash of the second secret.

26. The article of claim 25, instructions causing a machine to hash the second secret at the device to produce the hash of the second secret using the first public key, the second public key and a second random number generated from the tunnel protocol.

27. The article of claim 25, wherein the authenticator has a first private key, further comprising instructions causing a machine to:
encrypt the hash of the first secret using the second public key; and
place the encrypted hash into a message.

28. The method of claim 27, further comprising instructions causing a machine to sign the message with the first private key with a digital signature.

29. The article of claim 27, wherein the device comprises a second private key; and further comprising instructions causing a machine to:
check the digital signature using a first public key; and
decrypt the message using the second private key.

30. The article of claim 25, further comprising instructions causing a machine to:
determine if a hash value of the second public key matches a displayed hash value observed at the device; and
determine if the first secret matches a displayed secret observed at the device;
wherein the second secret is the displayed secret after entry into a network console connected to the authenticator.

31. The article of claim 30, wherein the device includes a label having the displayed hash value and the displayed secret.

32. The article of claim 29, wherein instructions causing a machine to determine if the hash value of the second public key matches comprises:
reading the displayed hash value; and
verifying the displayed hash value at a network console.

33. The article of claim 29, wherein instructions causing a machine to determine if secret matches comprises:
reading the displayed secret; and
entering the displayed secret at a network console.

34. The article of claim 29, wherein the device comprises a display and an application, the application rendering the displayed hash value and the displayed secret on the display.

35. The article of claim 25, wherein the authenticator comprises a first credential list and the device comprises a second credential list, further comprising instructions causing a machine to:
determine if the public key from the device is on the first credential list; and
determine if a public key from the device is in the second credential list.

36. The article of claim 25, wherein the authenticator comprises a first credential list and the device comprises a second credential list, further comprising instructions causing a machine to:
place the first public key in the second credential list; and
place the second public key in the first credential list.

37. An electronic apparatus comprising:
an authenticator comprising:
circuitry, for integrating a device into a secure network, to:
establish a tunnel between the authenticator and the device, the tunnel using a tunnel protocol, the authenticator having a first public key, the device having a second secret and a second public key;
hash a first secret using the first public key, a second public key and a random number generated from the tunnel protocol to produce a hash of the first secret;
send a hash of the second secret to the device for verification against a hash of the second secret; and
establish an authenticated session between the device and the authenticator when the hash of the first secret matches the hash of the second secret.

38. The apparatus of claim 37, wherein the authenticator has a first private key, the authenticator further comprising circuitry to:
encrypt the hash of the first secret using the second public key; and
place the encrypted hash into a message.

39. The apparatus of claim 38, the authenticator further comprising circuitry to sign the message with the first private key with a digital signature.

40. A consumer electronic product, comprising
a display;
memory;
a processor; and
circuitry to connect to a secure network, the circuitry comprising circuitry to:
establish a tunnel between an authenticator and the product, the tunnel using a tunnel protocol, the authenticator having a first public key, the product having a second secret and a second public key;
hash the second secret to produce the hash of the second secret using the first public key, the second public key and a random number generated from the tunnel protocol; and
establish an authenticated session between the device and the authenticator when a hash of the first secret matches the hash of the second secret.

41. The product of claim 40, wherein the product is a cellular phone.

42. The product of claim 40, wherein the product is a personal digital assistant.

43. The product of claim 40, wherein the product is a computer system.

44. The product of claim 40, wherein the product is a wireless camera.
